(19) United States
(12) Patent Application Publication
(10) Pub. No.: US 2014/0164188 A1
(43) Pub. Date: Jun. 12, 2014

(54) ONLINE AUTOMOBILE SELECTION AND SALES SYSTEMS AND METHODS

(71) Applicant: JIGSAW SYSTEMS, LLC, Billings, MT (US)

(72) Inventors: Stephen A. Zabawa, Billings, MT (US); Richard Carl Holland, South Jordan, UT (US); Thomas Murray, North Barrington, IL (US)

(73) Assignee: JIGSAW SYSTEMS, LLC, Billings, MT (US)

(21) Appl. No.: 14/099,791

(22) Filed: Dec. 6, 2013

Related U.S. Application Data
(60) Provisional application No. 61/734,731, filed on Dec. 7, 2012.

(51) Int. Cl. G06Q 30/06

(52) U.S. Cl. CPC G06Q 30/0635; G06Q 30/0625
USPC 705/26.62

(57) ABSTRACT

Examples described include online automobile selection and sales systems and methods. Systems and methods disclosed herein may provide a start-to-finish web-based automobile shopping and purchasing experience. Examples described may include a variety of software modules including, but not limited to, a buying module, a selecting module, a valuation module, a financing module, an interface module, and a data integration module. One or more software modules may be integrated into a single module and hosted on the same or different servers. A consumer may be able to obtain a commitment to purchase a trade-in vehicle at a specified price, a commitment to sell another vehicle at a specified price, and an approved financing package without the need for personal negotiations. In this manner, examples of the present invention may facilitate sales of automobiles over the Internet at any time of day or day of the year.

### CROSS-REFERENCE

This application claims the benefit of the earlier filing date of U.S. Provisional Application No. 61/734,731 filed Dec. 7, 2012, which application is incorporated herein by reference, in its entirety, for any purpose.

### TECHNICAL FIELD

Embodiments described herein relate generally to online automobile selection and sales systems and methods.

### BACKGROUND

Online marketplaces for goods, such as automobiles, may currently allow for a user to see an inventory at a particular dealership, or obtain information about automobiles. Despite growth in e-commerce, current online systems generally do not allow for a comprehensive automobile purchasing solution. Rather, customers often visit dealerships to buy a vehicle, and often engage in lengthy negotiations before reaching mutually acceptable terms for purchase of the vehicle.

When a dealer's potential customer is approaching the decision to buy a vechicle, data from a large number of sources may be required to work together to provide the factual and legal foundations for the transaction. The sources of this information may be car manufacturers, state registers of driving license holders and cars, credit rating agencies, potential lenders, insurance companies, and/or many others.

There is no vehicle industry standard that defines how this information is made available. Each system has its own complex and unique method of accessing the data, with no industry common standard for communicating between systems. Some of these sources may have multiple interfaces while others may have few, and the relative complexity and quality varies. This may lead to a break-down in efficiency, requiring multiple integrations, and in some cases, a loss or corruption of data.

### BRIEF DESCRIPTION OF THE DRAWINGS

FIG. 1 is a schematic illustration of a system for online automobile selection and sales, according to some examples.

FIG. 2 is a schematic illustration of a system for online automobile selection and sales, according to some examples.

FIG. 3 is a schematic illustration of a system for online automobile selection and sales, according to some examples.

FIG. 4 is a flow chart depicting a method for online automobile selection and sales, according to some examples.

FIG. 5 is a flow chart depicting a method for online automobile selection and sales, according to some examples.

FIG. 6 is an interface view of a selecting module of a system for online automobile selection and sales, according to some examples.

FIG. 7 is an interface view of a valuation module of a system for online automobile selection and sales, according to some examples.

FIG. 8 is an interface view of a financing module of a system for online automobile selection and sales, according to some examples.

FIG. 9 is an interface view of a data integration module of a system for online automobile selection and sales, according to some examples.

FIG. 10 is a schematic illustration of a data integration module, according to some examples.

### DETAILED DESCRIPTION

Certain details are set forth below to provide a sufficient understanding of embodiments of the invention. However, it will be clear to one skilled in the art that embodiments of the invention may be practiced without various of these particular details. In some instances, well-known computer hardware, materials, electronic components, circuits, control signals, timing protocols, and software operations have not been shown in detail in order to avoid unnecessarily obscuring the described embodiments of the invention.

Disclosed herein are example embodiments of systems, apparatuses and methods for online automobile selection and sales. As mentioned above, existing systems and methods for online automobile selection and sales may be cumbersome and offer limited functionality. Therefore, there may be a need for user friendly systems and methods to perform a start-to-finish web-based automobile shopping and purchasing experience.

Software as a service (“SaaS”) systems may be provided in some examples to implement the online automobile selection and sales system. SaaS may provide web service software technology that may be usable for consumers, automobile dealerships, and/or financial institutions. Accordingly, embodiments disclosed herein may include one or more computing systems (e.g. servers, desktops, laptops, tablets, phones, and other computing systems having one or more processing unit(s)) programmed to provide the purchasing services described herein. The computing systems may be providing a software as a service, which may for example provide access to the purchasing services for a license and/or commissionable fee, or may provide one or more applications for the purchasing services to a client device for a licensing fee. The application provided to a client device may be disabled after use or after the application is set to expire. In this manner, the on-demand function may be managed to share licenses within a firm or by a third-party application service provider (ASP) sharing licenses between firms. Examples of vendors that have provided SaaS and may provide SaaS for purchasing systems as described herein include, but are not limited to, SAP BUSINESS ByDESIGN, GOOGLE APPS, MICROSOFT, APPLE, ANDROID, and BLACKBERRY. The purchasing services hosted by a SaaS may be accessed from a web browser on a client device (e.g. computing system such as but not limited to desktop, laptop, personal digital assistant, tablet, cellular phone, appliance, etc.). Software and data may be stored on the SaaS server(s) in computer readable media accessible to the SaaS server(s).

Accordingly, disclosed embodiments may include one or more computer readable mediums encoded with instructions that cause one or more processing unit(s) to perform particular actions to provide the purchasing services described. The processing unit(s) may include one or more processors, or circuitry configured to perform processing tasks described. The computer readable mediums may be transitory or non-transitory and may include, but are not limited to any type of electronic memory, CDROM, optical disk, hard disk, or other electronic storage.

Examples disclosed herein may serve as a single source solution which may include all applications necessary to facilitate an online automotive purchase—for example, a cloud-based web service may be provided for integration with a dealer's data management system/website to provide real-time data facilitation between a consumer, lender, and dealer. In some examples, the cloud-based web service may operate without human interaction such that a potential buyer may interact with the cloud-based web service. In some examples, by utilizing the system for online automobile selection and sales disclosed herein, superfluous negotiations and dealings that may occur at the dealership may be reduced. Thus, time requirements spent at the dealer's physical location may be greatly reduced or eliminated. In some examples, by utilizing systems described herein, a consumer may be able to obtain a commitment to purchase a trade-in vehicle at a specified price, a commitment to sell another vehicle at a specified price, and an approved financing package, all in some examples without the need for personal negotiations. In this manner, examples of the present invention may facilitate sales of automobiles over the Internet at any time of day or day of the year.

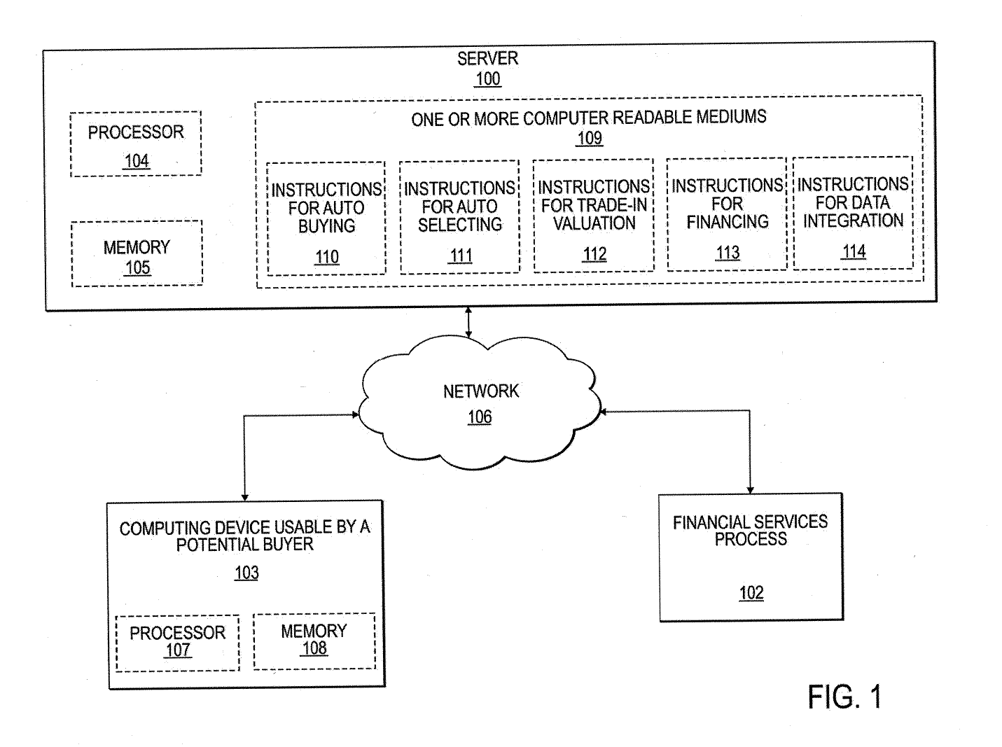

FIG. 1 is a schematic illustration of a system for online automobile selection and sales, according to some examples. A system for online automobile selection and sales may include a server 100 housing memory 105 in communication with one or more processing unit(s) 104 and one or more computer readable mediums 109 that may be encoded with instructions that, when executed by the one or more processing unit(s) 104, cause the one or more processing unit(s) 104 to perform actions to provide the automobile selection and sales services described herein. Other electronic storage may be in communication with the server 100. The system for online automobile selection and sales may also include a computing device usable by a potential buyer 103 housing memory 108 in communication with one or more processing unit(s) 107.

The server 100 of the online automobile selection and sales system may be accessible over a network 106 to a dealer computing system 300, a computing device usable by a potential buyer 103 (also referred to herein as a “consumer system”), a financial services process 102, or combinations thereof. The computing device usable by a potential buyer 103, financial services process 102, and/or dealer computing system 300 may be implemented using any electronic device suitable for communication with the software modules described herein, for example, mobile devices such as but not limited to tablets and cellular telephones, as well as other computing systems such as laptops, desktops, servers, etc. may be used to access the SaaS servers described herein. In some examples, the dealer computing system 300, consumer system 103, and/or financial services process 102 may be in communication with the server 100 of the online automobile selection and sales system using a web browser. As described further herein, the server 100 may access information provided by and/or stored at the dealer computing system 300, consumer system 103, and/or financial services process 102 and may triangulate the three. The server 100 may further provide information to the dealer computing system 300, consumer system 103, and/or financial services process 102 to facilitate auto purchasing as described herein.

In some examples, to facilitate end-to-end automobile purchasing, a variety of software modules (e.g. software applications) may be programmed on the server 100. Although described as different modules herein, in some examples two or more of the modules may be integrated into a single module. Modules may include, but are not limited to, a buying module, a selecting module, a valuation module, a financing module, an interface module, and a data integration module. The different modules may interact with each other and with the dealer computing system 300, consumer system 103, and/or financial services process 102 as described herein. It is also to be understood that configurations of computing systems in accordance with embodiments disclosed herein are flexible. For example, any number of processing unit(s) and/or computer readable mediums and/or servers may be used to provide the online automobile selection and sales system described herein. The software modules described herein may be hosted on the same or different servers and all or certain ones of the software modules may be hosted by the dealer computing system 300, consumer system 103, and/or financial services process 102 in some examples.

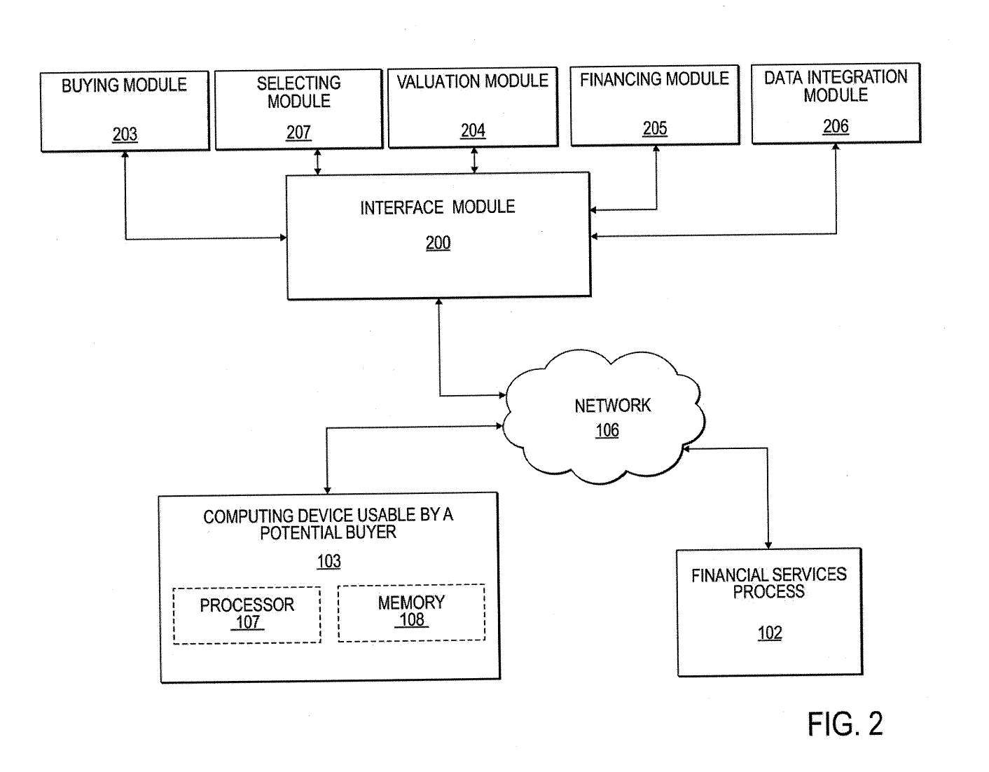

FIG. 2 is a schematic illustration of a system for online automobile selection and sales, according to some examples. In some examples, an interface module 200, the buying module 203, the valuation module 204, the selecting module 207 and the financing module 205 may be located in distinct servers. The buying module 203, the valuation module 204, and the financing module 205 may be in communication with the interface module 200 to communicate with the computing device usable by a potential buyer 103. In some examples, interface module 200 may transmit data received from the buying module 203, the valuation module 204, and the financing module 205 to the data integration module 206 in order to aggregate the data, as will be described below. The interface module 200 may communicate with the computing device usable by a potential buyer 103 and the financial services process 102 through the network 106.

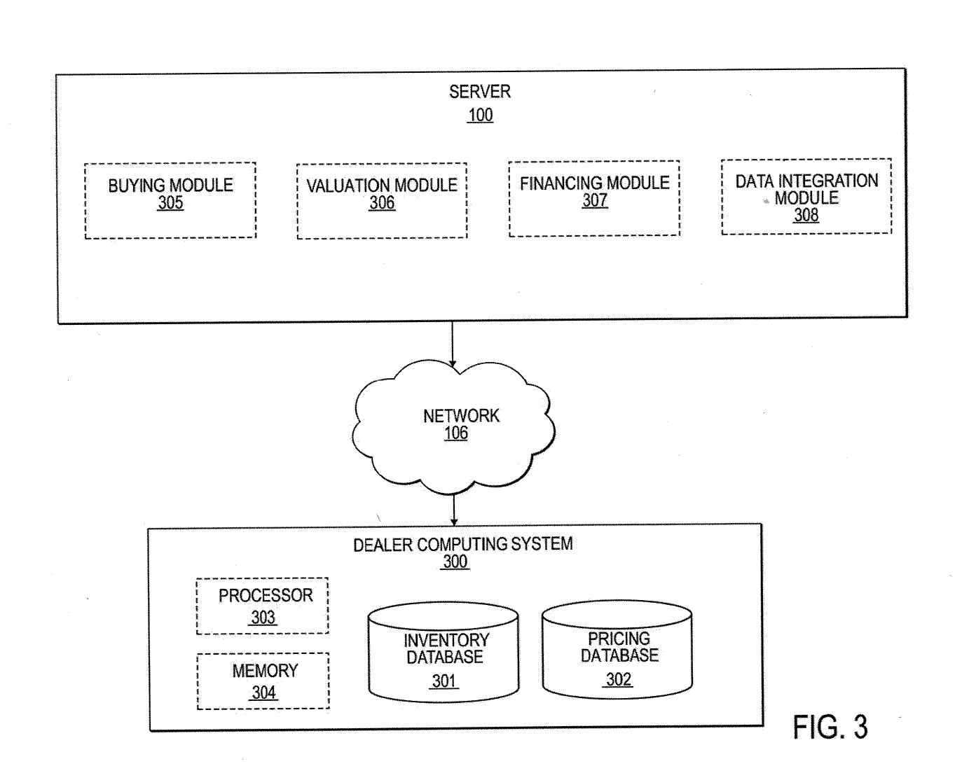

FIG. 3 is a schematic illustration of a system for online automobile selection and sales, according to some examples. In some examples, the server 100 may house the buying module 305, the valuation module 306, the financing module 307, and the data integration module 308. The server may communicate with the dealer computing system 300 through the network 106. The dealer computing system 300 may include memory 304 in communication with a processor 303. The dealer computing system 300 may also include an inventory database 301 and a pricing database 302. The inventory database 301 may be queried to determine if a certain vehicle is in-stock at the dealership. The pricing database 302 may be queried to determine pricing information of a certain vehicle. In some examples, the inventory database 301 and the pricing database 302 may be stored in a storage device housed within the dealer computing system 300. The inventory database 301 and the pricing database 302 may utilize any known database format, for example SQL. While the inventory database 301 and the pricing database 302 are shown in FIG. 3 associated with the dealer computing system, the inventory database 301 and the pricing database 302 may be in other examples associated with the server 100. Generally, the inventory database 301 and the pricing database 302 may be electronically accessible to processes running on the server 100 performing functions described herein which rely on information stored in the inventory database 301 and/or pricing database 302.

Embodiments of the present invention may further provide a dealer interface which allows dealers to input and/or adjust prices for trade-in vehicles and/or vehicles in their dealer inventory that are acceptable to the dealer. For example, a dealer may enter prices at which the dealer is known to be willing to purchase a particular trade-in vehicle, or class of trade-in vehicles. A dealer may enter prices at which the dealer is willing to sell a particular vehicle, or class of vehicles, in their inventory. The pricing information may be stored in pricing database 302 and/or in another location accessible by the server 100. In some examples, the server may present the dealer with baseline pricing selections (e.g. related to current auction values on trade-in vehicles, or market or other valuation data regarding vehicles in the dealer's inventory) and the dealer may adjust the pricing information based on the dealer's own preferences (e.g. perceived difficulty or ease in selling a particular vehicle in their particular market at a particular time).

In this manner, a dealer may maintain updated pricing information at which the dealer is known to be willing to sell vehicles or purchase trade-in vehicles. This known information may be used by processes described herein to put together a firm trade-in price and/or sales price for a consumer without further personal input from the dealer.

The different modules described herein may receive real-time or periodic data feeds from a variety of data sources that may be useful in conducting the transactions described herein including, but not limited to, information from car manufacturers, state registers of driving license holders and cars, credit rating agencies, potential lenders, CarFax, and insurance companies. The data may be provided, for example, by a live feed to the appropriate module or the server 100 such that the data is updated a particular intervals or in real time.

The modules may function together to provide an end-to-end shopping experience for a consumer. The modules may facilitate connection of a number of data sources and extract relevant data elements that may be delivered between modules as event-enabled data flow. In this manner, modules may “listen” to state changes and perform any necessary data transformations to update a next module. Each module, or in some examples combinations of modules, may be autonomous, which may reduce a risk that a problem interrupting one data flow may affect others.

The buying module 203 may include one or more computer readable mediums encoded with instructions for auto buying 110. Using the buying module 203, consumers (also referred to herein as a “potential buyer”) may begin an interaction with a dealer by, for example, specifying vehicle preferences. The buying module 203 may transmit information usable by the consumer regarding vehicles selected based, at least in part, on preferences of the consumer. The buying module 203 may enable customers to interact with one or more dealers over the network 106, which may develop and cultivate the consumer/dealer relationship. For example, the consumer may use the consumer system 103 to transmit an indication of interest in a certain vehicle to the buying module 203. The indication of interest may include a transmission of information from the consumer system 103 to the buying module 203 identifying the certain vehicle. By providing an interactive web-service application designed to facilitate a seamless, consumer-centric purchase experience that provides a single portal and a system to provide the consumer with a start-to-finish purchase process, dealers may improve their closing and retention attachment rates.

In some examples, the buying module 203 may serve as a hub for the other modules to communicate information on an event basis. In this manner, a consumer at any time may access the buying module 203 to conduct a complete vehicle purchase including, but not limited to, selecting a car, obtaining a trade-in valuation, and obtaining financing. The consumer may then visit the dealer at an acceptable time to turn in their trade-in and pick up their vehicle or have the vehicle delivered to the location of their choosing. In some examples, the buying module 203 may include a guide to explain the process to the consumer. The guide may provide a full process disclosure, federal and state compliance information, and/or recurring video popups. Similar functionality may also be provided by the interface module 200.

The selecting module 207 may include one or more computer readable mediums encoded with instructions for auto selecting 111. The selecting module 207 may utilize analytics, such as artificial intelligence analytics, in conjunction with communication with a dealer's inventory on one or more dealer computing systems, to provide suggestions or otherwise guide a consumer to select a vehicle for a purchase meeting their needs. In some examples, the analytics involve weighting certain consumer preference parameters and financing parameters associated with the consumer so as to increase or decrease the importance of these parameters. In some examples, the searching module may search the inventory of one or more dealers to find or suggest vehicles for a consumer based on attributes provided or inferred about a consumer's preferences.

The valuation module 204 may include one or more computer readable mediums encoded with instructions for trade-in valuation 112. The valuation module 204 may provide a binding valuation of the consumer's trade-in vehicle that is guaranteed to be accepted by the dealer provided the car is in the condition stated by the consumer. The valuation module 204 may provide a consumer with a real-time appraisal, and an instant purchase offer to allow a dealer to purchase the consumer's vehicle, regardless of whether the consumer buys a vehicle from the dealer. In some examples, the valuation module 204 may be in communication with the financing module 205 to provide the consumer system 103 with a real time lending approval, as will be described below. The valuation module 204 may access stored information about acceptable pricing of the certain vehicle and transmit information to a computing device usable by the potential buyer indicative of a price for the certain vehicle known to be acceptable to the dealer based on the stored information about acceptable pricing. The valuation module 204 may also access stored information regarding acceptable pricing of a trade-in vehicle after receiving from the computing device usable by the potential buyer information regarding the trade-in vehicle. The stored information regarding acceptable pricing of the certain vehicle and the trade-in vehicle may be located in the pricing database 302 of the dealer computing system 300.

The financing module 205 may include one or more computer readable mediums encoded with instructions for financing 113. The financing module 205 may provide lending decisions without human involvement. In some examples, the financing module 205 may be in communication with a financial services process 102 through the network 106. The financial services process 102 may include one or more lender systems of one or more financial institutions implemented to transmit lending decisions to the financing module 205. In some examples, the financial services process 102 may be located on the same computer system as the financing module 205. The financing module 205 may utilize information from the financial services process 102 to offer the consumer financing options for the selected automobile.

The financing module 205 may receive financial information from and/or about a consumer and may communicate with the financial services process 102 to receive bids from one or more lenders to provide financing to a computing device usable by a potential buyer 103. The consumer may then select between financing options. Financial information may include a credit check, a credit score, a requested loan amount consumer data, employment information, wealth information, value of trade-in vehicle, etc. In some examples, the financing module 205 may verify the financial information of the potential buyer before providing the financial information to the financial services process 102. In some examples, the financing module 205 may electronically execute a financing package between the financial institution and the potential buyer.

The data integration module 206 may include one or more computer readable mediums encoded with instructions for data integration 114. The data integration module 206 may facilitate the data integration between the other modules. For example, the data integration module 206 may provide additional functionality to any of the above modules by providing analytics that support automobile selection, valuation, and/or financing analysis. The data integration module 206 may facilitate data transfer between modules and from third party sources of information in a manner that allows for communication of the data between the modules.

The data integration module 206 may utilize mathematical equations and algorithms to enhance efficiency. For example, the data integration module 206 may match consumer desires with dealer in-stock inventory. In some examples, certain consumer desires are weighted so as to increase or decrease their importance. The data integration module 206 may perform mathematical calculations to guide a consumer through various payment and financing options for purchase of a desired vehicle. For example, the consumer may be presented with choices to lease, finance, pay cash, and/or finance with their lender. The data integration module 206 may present the consumer with alternate vehicle choices based on financing decisions made by lenders. In some examples, the data integration module 206 may optimize consumer loan options by allowing consumers to match qualified payment with in-stock inventory. In this manner, the consumer may be guided down a logical path of choices to arrange financing that best suits their needs without human dealership input. Through these data integrations, dealer gross profits may be increased and dealers may manage their inventory. In addition, consumer process fulfillment may be increased, thereby yielding higher dealer attachment/closing rates.

The interface module 200 may include one or more computer readable mediums encoded with instructions for transmitting and receiving information from the computing device usable by the potential buyer 103. The interface module may transmit information to the computing device usable by the potential buyer 103 indicative of a price of the certain vehicle acceptable to the dealer and the financing approval from the financial institution. The interface module 200 may transmit information regarding a purchase price of the trade-in vehicle known to be acceptable to the dealer to the computing device usable by the potential buyer 103.

The interface module 200 may receive, from the computing device usable by the potential buyer 103, acceptance of a transaction including purchase price of the certain vehicle at the price, sale of the trade-in vehicle at the purchase price, and/or financing of the price with the financial institution. The interface module 200 may transmit to the computing device usable by the potential buyer, a purchase offer comprising the purchase price known to be acceptable to the dealer and known to be acceptable to the potential buyer. If the purchase offer is accepted by the potential buyer, then the interface module 200 may electronically execute a purchase agreement between the potential buyer and the dealer. In some examples, the potential buyer may be offered accessories for the vehicle before executing the purchase offer.

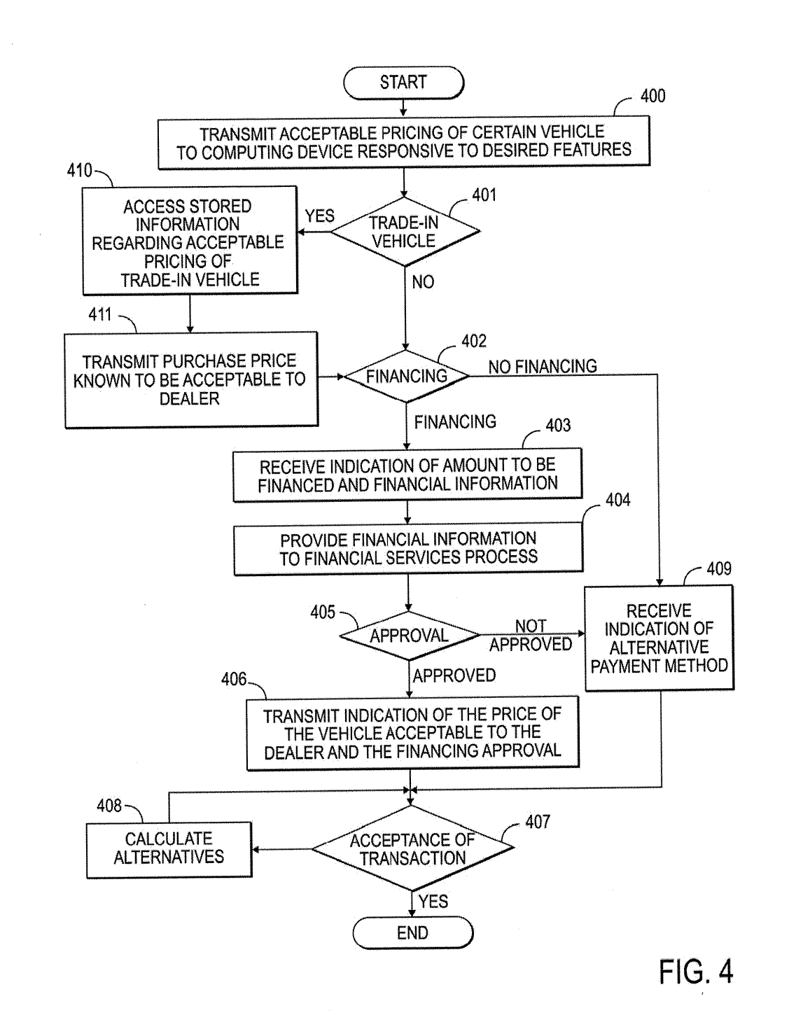

FIG. 4 is a flow chart depicting a method for online automobile selection and sales, according to some examples. Operation 400 involves transmitting acceptable pricing of a certain vehicle to a computing device responsive to desired features. Operation 401 involves querying whether there is a trade-in vehicle. If yes, then Operation 410 involves accessing stored information regarding acceptable pricing of the trade-in vehicle. Operation 411 involves transmitting the purchase price known to be acceptable to the dealer. After transmitting the purchase price known to be acceptable to the dealer or if there was no trade-in vehicle, then Operation 402 involves querying whether the consumer operating the computing device desires financing. If financing is desired, then Operation 403 involves receiving an indication of an amount to be financed and financial information of the consumer. Operation 404 involves providing the financial information received from the consumer to the financial services process. Operation 405 involves querying the financing is approved. If the financing was approved, then Operation 406 involves transmitting an indication of the price of the vehicle acceptable to the dealer and the financing approval. If no financing was desired or the financing was not approved, then Operation 409 involves receiving an indication of an alternate payment method. After receiving an indication of an alternate payment method (Operation 409) or transmitting an indication of the price of the vehicle acceptable to the dealer and the financing approval (Operation 406), Operation 407 involves querying whether the transaction is accepted. If no, then Operation 408 involves calculating alternatives and repeating Operation 407. Depending on consumer feedback as to why the transaction was not accepted, any of the aforementioned operations may be repeated.

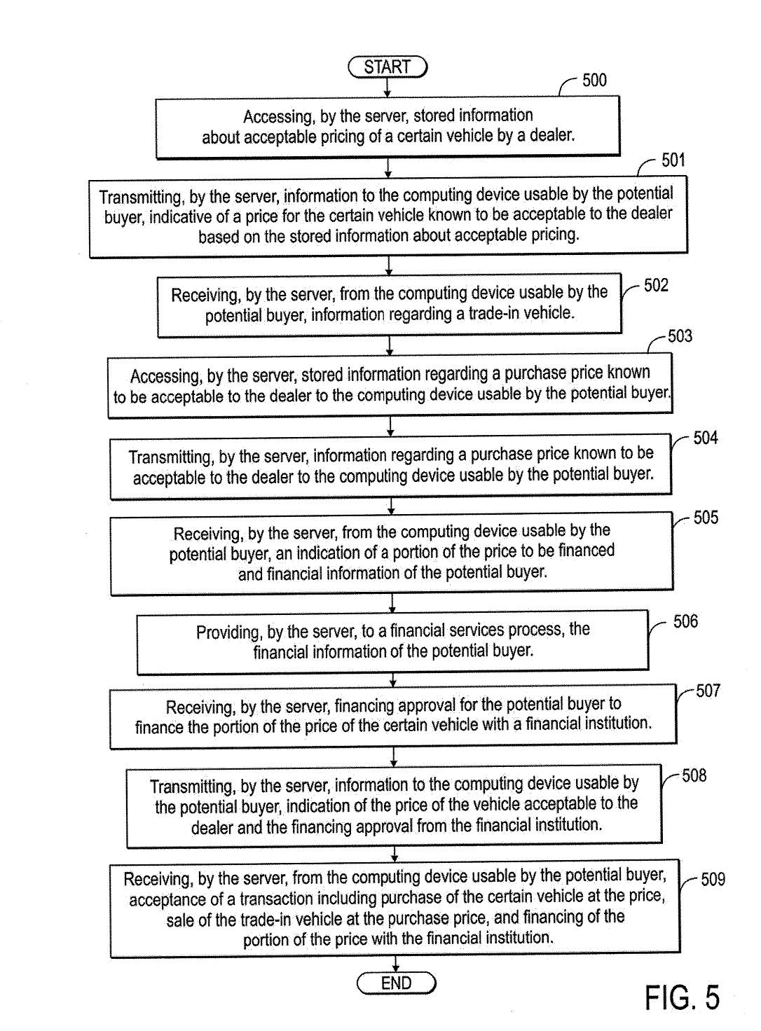

FIG. 5 is a flow chart depicting a method for online automobile selection and sales, according to some examples. Operation 500 involves accessing, by the server, stored information about acceptable pricing of a certain vehicle by a dealer. Operation 501 involves transmitting, by the server, information to the computing device usable by the potential buyer, indicative of a price for the certain vehicle known to be acceptable to the dealer based on the stored information about acceptable pricing. Operation 502 involves receiving, by the server, from the computing device usable by the potential buyer, information regarding a trade-in vehicle. Operation 503 involves accessing, by the server, stored information regarding a purchase price known to be acceptable to the dealer to the computing device usable by the potential buyer. Operation 504 involves transmitting, by the server, information regarding a purchase price known to be acceptable to the dealer to the computing device usable by the potential buyer. Operation 505 involves receiving, by the server, from the computing device usable by the potential buyer, an indication of a portion of the price to be financed and financial information of the potential buyer. Operation 506 involves providing, by the server, to a financial services process, the financial information of the potential buyer. Operation 507 involves receiving, by the server, financing approval for the potential buyer to finance the portion of the price of the certain vehicle with a financial institution. Operation 508 involves transmitting, by the server, information to the computing device usable by the potential buyer, indication of the price of the vehicle acceptable to the dealer and the financing approval from the financial institution. Operation 509 involves receiving, from the computing device usable by the potential buyer, acceptance of a transaction including purchase of the certain vehicle at the price, sale of the trade-in vehicle at the purchase price, and financing of the portion of the price with the financial institution.

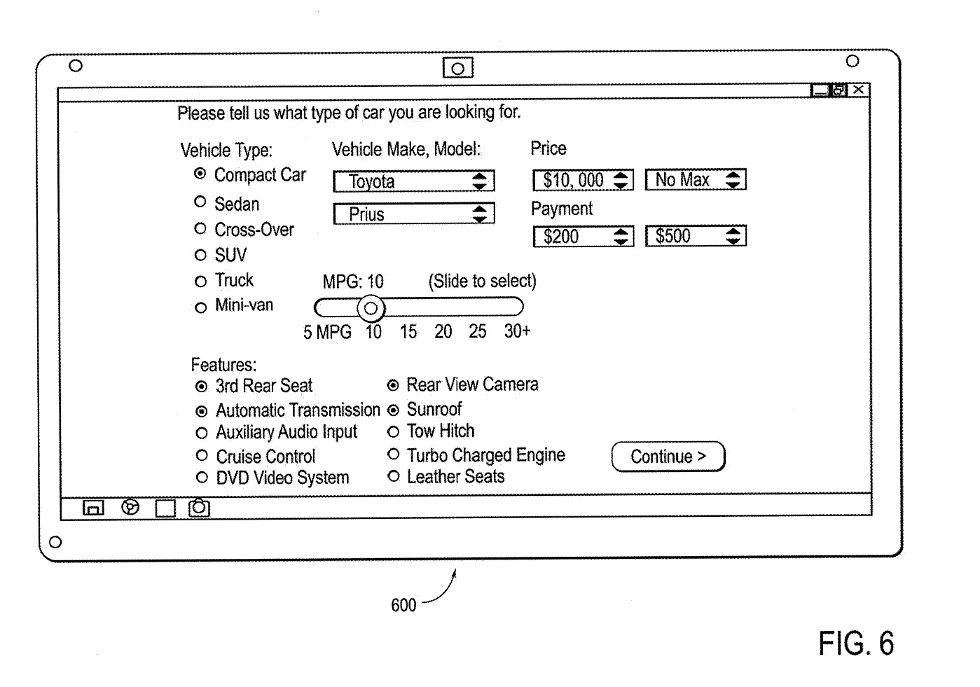

FIG. 6 is an interface view of a selecting module 207 of a system for online automobile selection and sales, according to some examples. The selecting module 207 may include a selection interface 600 in which a consumer may select features for their desired vehicle. Features may include vehicle type, make, model, price, down payment, miles per gallon (MPG), and other features. Based on the consumer's criteria, the selecting module 207 may search the inventory of one or more dealers to find vehicles suitable for the consumer. In some examples, the vehicles suitable for the consumer may be presented in the selection interface 600.

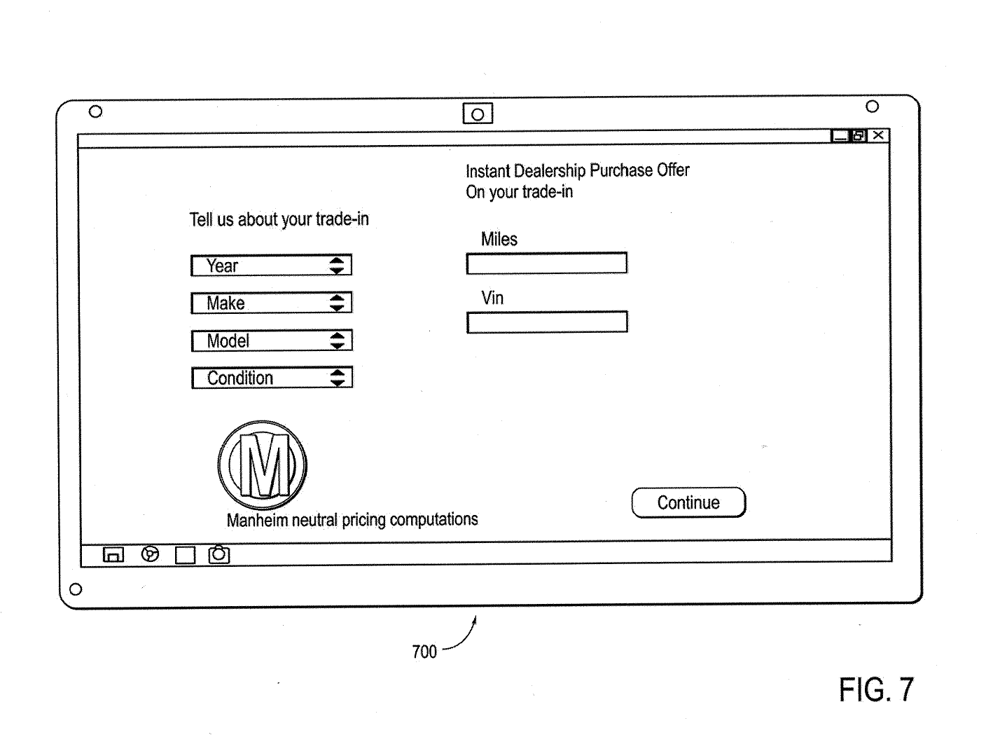

FIG. 7 is an interface view of a valuation module 204 of a system for online automobile selection and sales, according to some examples. The valuation module 204 may include a valuation interface 700 in which a consumer may enter information about their trade-in vehicle in order to receive an appraisal. The information about their trade-in vehicle may include year, make, model, condition, miles and vehicle identification number (VIN). The valuation module 204 may utilize known pricing algorithms, for example Manheim neutral pricing computations, or proprietary algorithms to perform the appraisal. In some examples, the appraisal may be presented in the valuation interface 700.

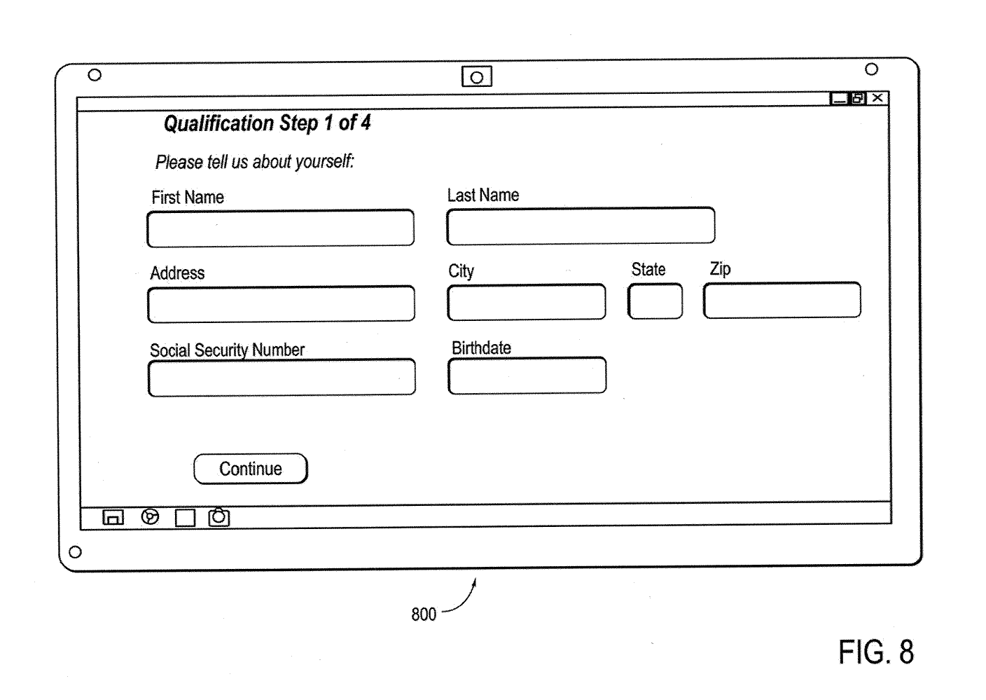

FIG. 8 is an interface view of a financing module 205 of a system for online automobile selection and sales, according to some examples. The financing module 205 may include a financing interface 800 in which a consumer may enter identification information in order to receive an assessment of their credit. The identification information may include name, address, city, state, zip, social security number, and birthdate. The financing module 205 may use the identification information to create a financial scorecard to aid dealers and lenders via a secured consumer credit application. In some examples, the financial scorecard may be presented to the consumer in the financing interface 800.

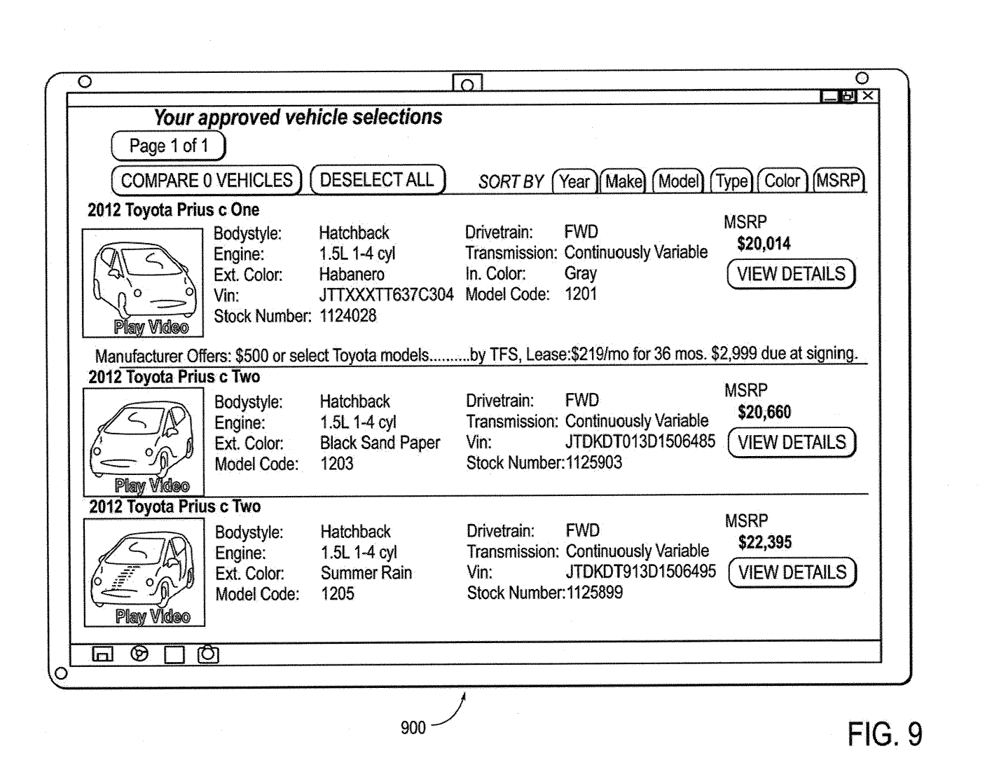

FIG. 9 is an interface view of a data integration module of a system for online automobile selection and sales, according to some examples. The data integration module may include a data integration interface 900 in which data regarding consumer qualifications, lending parameters, trade-in values, and inventory may be aggregated to create a web interface in which the consumer is presented with “option packages.”

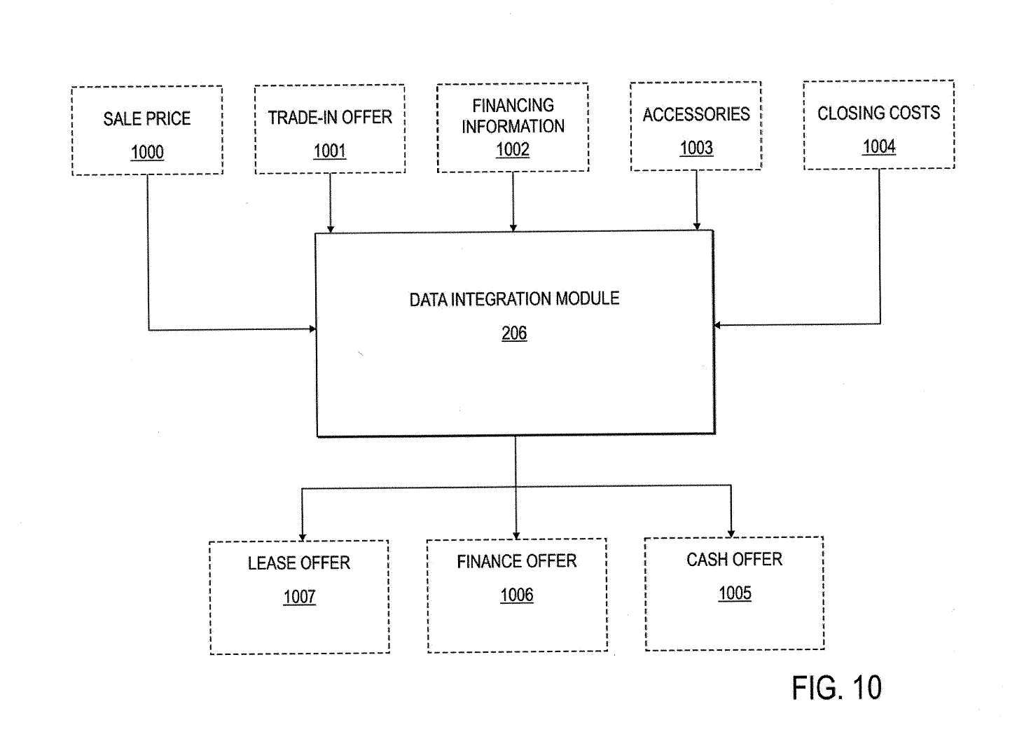

FIG. 10 is a schematic illustration of a data integration module 206, according to some examples. The data integration module 206 may receive data from the other modules, such as sale price 1000, trade-in offer 1001, financing information 1002, accessories 1003, and closing costs 1004. The data integration module 206 may aggregate this data to provide option packages, such as a lease offer 1007, a finance offer 1006, and/or a cash offer 1005. The option packages may be transmitted to the consumer system 103 for acceptance or further modification. Upon acceptance, the consumer may add a desired option package to a “cart” and enter a checkout process whereby payment information may be entered, the purchase agreement may be electronically executed, and/or pick-up arrangements may be determined.

Embodiments of the systems and methods described herein may provide a variety of models for payment to dealers or other service providers participating in the system. Generally, current compensation models in the industry rely on a “Dealer Reserve” commission model that creates an environment whereby a “Finance and Insurance” (“F&I, Financial Services, Business Manager, etc.”), sends the consumer's credit application to multiple lenders to acquire the lowest, “buy rate,” and then is able to “re-sell” the loan with a margin or mark-up built in. The dealer is able to arbitrarily marks-up the loan, generally up to 500 basis points, and the dealership then receives a commission from the lender for the “reserve,” predicated upon the mark-up, “sold” to the consumer at the point of sale. This model has become problematic in its lack of transparency to the consumer.

Examples of the present invention may provide a flat commission to the dealer, predicated upon the loan amount originated by the dealer, and funded, on an indirect basis, to the consumer. This eliminates or reduces the potential for liability in both the dealer and lender venues, as this creates a common annual percentage rate offered to the consumer on the basis of their credit score, down payment, term, or other financial terms, and does not involve adjustment by the dealer themselves. In this manner, the dealer may eliminate or reduce their risk of obscuring or unfairly adjusting loan rates offered to a particular consumer.

Accordingly, in examples of the present invention, financial service providers who have agreed to make financing available through the system, e.g. a financial service provider participating in financial services process 102 of FIG. 2, may have agreed to compensate dealers at a flat commission for financing completed on vehicles sold through the dealer's inventory. On completion of a sale, the financial service provider may pay the flat commission to the dealer, for example by the financial services process 102 of FIG. 2 communicating with a financial services process of a dealer to transfer funds from the financial service provider to the dealer. The flat commission in some examples may be based on loan amount, term, credit scorecard of the consumer, or other factors. In some examples, the flat commission may be a same commission per loan or per dollar loaned. The flat commission may be unrelated to any markup or alteration of an interest rate by the dealer. In this manner, the dealer may reduce or eliminate risk associated with themselves by determining or adjusting a lending rate.

From the foregoing it will be appreciated that, although specific embodiments of the invention have been described herein for purposes of illustration, various modifications may be made without deviating from the spirit and scope of the invention.

What is claimed is:

1. A method for online automobile selection and sales comprising:
receiving, at a server, an indication of interest in a certain vehicle from a potential buyer, wherein the indication of interest is received following transmission of information from the server to a computing device usable by the potential buyer regarding vehicles selected based, at least in part, on preferences of the potential buyer;
accessing, by the server, stored information about acceptable pricing of the certain vehicle by a dealer;
transmitting, by the server, information to the computing device usable by the potential buyer, indicative of a price for the certain vehicle known to be acceptable to the dealer based on the stored information about acceptable pricing;
receiving, by the server, from the computing device usable by the potential buyer, information regarding a trade-in vehicle;
accessing, by the server, stored information regarding acceptable pricing of the trade-in vehicle by the dealer;
transmitting, by the server, information regarding a purchase price known to be acceptable to the dealer to the computing device usable by the potential buyer;
receiving, by the server, from the computing device usable by the potential buyer, an indication of a portion of the price to be financed and financial information of the potential buyer;
providing, by the server, to a financial services process, the financial information of the potential buyer;
receiving, by the server, financing approval for the potential buyer to finance the portion of the price of the certain vehicle with a financial institution;
transmitting, by the server, information to the computing device usable by the potential buyer, indication of the price of the vehicle acceptable to the dealer and the financing approval from the financial institution; and
receiving, by the server, from the computing device usable by the potential buyer, acceptance of a transaction including purchase of the certain vehicle at the price, sale of the trade-in vehicle at the purchase price, and financing of the portion of the price with the financial institution.

2. The method of claim 1, wherein the indication of interest comprises a transmission of information from the computing device usable by the potential buyer to the server identifying the certain vehicle.

3. The method of claim 1, wherein the stored information about acceptable pricing of the certain vehicle by a dealer is accessible by querying a database comprising acceptable pricing criteria of the dealer.

4. The method of claim 1, further comprising verifying, by the server, the financial information of the potential buyer before providing the financial information to the financial services process.

5. The method of claim 1, further comprising transmitting, by the server, to the computing device usable by the potential buyer, a purchase offer comprising the purchase price known to be acceptable to the dealer and known to be acceptable to the potential buyer.

6. The method of claim 1, further comprising electronically executing, by the server, a financing package between a financial institution and the potential buyer.

7. The method of claim 1, wherein acceptance of the transaction comprises electronically executing a purchase agreement between the potential buyer and the dealer.

8. The method of claim 1, wherein the financial service process is configured to deliver financing approval based on, at least in part, the financial information of the potential buyer.

9. The method of claim 1, wherein the financial information comprises at least one of credit score, wealth, income, and employment.

10. The method of claim 1, wherein vehicles selected based, at least in part, on preferences of the potential buyer comprises performing analytics, the analytics comprising weighting preference parameters and financing parameters.

11. A non-transitory computer accessible medium having stored thereon computer executable instructions that, when executed by a processing unit, configure the processing unit to:
receive an indication of interest in a certain vehicle from a potential buyer, wherein the indication of interest is received following transmission of information from the server to a computing device usable by the potential buyer regarding vehicles selected based, at least in part, on preferences of the potential buyer;
access stored information about acceptable pricing of the certain vehicle by a dealer;
transmit information to the computing device usable by the potential buyer, indicative of a price for the certain vehicle known to be acceptable to the dealer based on the stored information about acceptable pricing;
receive from the computing device usable by the potential buyer, information regarding a trade-in vehicle;
access stored information regarding acceptable pricing of the trade-in vehicle by the dealer;
transmit information regarding a purchase price known to be acceptable to the dealer to the computing device usable by the potential buyer;
receive from the computing device usable by the potential buyer, an indication of a portion of the price to be financed and financial information of the potential buyer;
provide to a financial services process, the financial information of the potential buyer;
receive financing approval for the potential buyer to finance the portion of the price of the certain vehicle with a financial institution;
transmit information to the computing device usable by the potential buyer, indication of the price of the vehicle acceptable to the dealer and the financing approval from the financial institution; and
receive, from the computing device usable by the potential buyer, acceptance of a transaction including purchase of the certain vehicle at the price, sale of the trade-in vehicle at the purchase price, and financing of the portion of the price with the financial institution.

12. The computer accessible medium of claim 11, wherein the indication of interest comprises a transmission of information from the computing device usable by the potential buyer to the server identifying the certain vehicle.

13. The computer accessible medium of claim 11, wherein the stored information about acceptable pricing of the certain vehicle by a dealer is accessible by querying a database comprising acceptable pricing criteria of the dealer.

14. The computer accessible medium of claim 11, further comprising computable executable instructions that, when executed by the processing unit to verify the financial information of the potential buyer before providing the financial information to the financial services process.

15. The computer accessible medium of claim 11, further comprising computable executable instructions that, when executed by the processing unit to transmit to the computing device usable by the potential buyer, a purchase offer comprising the purchase price known to be acceptable to the dealer and known to be acceptable to the potential buyer.

16. The computer accessible medium of claim 11, further comprising computable executable instructions that, when executed by the processing unit to electronically execute a financing package between a financial institution and the potential buyer.

17. The computer accessible medium of claim 11, wherein acceptance of the transaction comprises electronically executing a purchase agreement between the potential buyer and the dealer.

18. The computer accessible medium of claim 11, wherein the financial service process is configured to deliver financing approval based on, at least in part, the financial information of the potential buyer.

19. The computer accessible medium of claim 11, wherein the financial information comprises at least one of credit score, wealth, income, and employment.

20. The computer accessible medium of claim 11, wherein vehicles selected based, at least in part, on preferences of the potential buyer comprises performing analytics, the analytics comprising weighting preference parameters and financing parameters.

21. A system for online automobile selection and sales comprising:
a buying module configured to transmit information usable by a potential buyer regarding vehicles selected based, at least in part, on preferences of the potential buyer and receive an indication of interest in a certain vehicle from the potential buyer;
a valuation module configured to access stored information about acceptable pricing of the certain vehicle and transmit information to a computing device usable by the potential buyer indicative of a price for the certain vehicle known to be acceptable to the dealer based on the stored information about acceptable pricing, the valuation module further configured to access stored information regarding acceptable pricing of a trade-in vehicle after receiving from the computing device usable by the potential buyer information regarding the trade-in vehicle;
a financing module configured to receive an indication of a portion of the price to be financed and financial information of the potential buyer from the computing device, the financing module further configured to provide the financial information of the potential buyer to the server of a financial services process and receive financing approval for the potential buyer to finance the portion of the price of the certain vehicle with a financial institution;
a data integration module configured to aggregate the preferences of the potential buyer, acceptable pricing of the trade-in vehicle, and the financing approval for the potential buyer; and
an interface module configured to transmit information to the computing device usable by the potential buyer indicative of a price of the certain vehicle acceptable to the dealer and the financing approval from the financial institution, the interface module further configured to transmit information regarding a purchase price of the trade-in vehicle known to be acceptable to the dealer to the computing device usable by the potential buyer, and the interface module further configured to receive, from the computing device usable by the potential buyer, acceptance of a transaction including purchase price of the certain vehicle at the price, sale of the trade-in vehicle at the purchase price, and financing of the price with the financial institution.

22. The system of claim 21, wherein one or more of the valuation module, buying module, data integration module, interface module, and financing module are incorporated within a SaaS server.

23. The system of claim 21, wherein one or more of the valuation module, buying module, data integration module, interface module, and financing module are incorporated within distinct servers.

24. The system of claim 21, wherein the indication of interest comprises a transmission of information from the computing device usable by the potential buyer to the server identifying the certain vehicle.

25. The system of claim 21, wherein the stored information about acceptable pricing of the certain vehicle by a dealer is accessible by querying a database comprising acceptable pricing criteria of the dealer.

26. The system of claim 21, wherein the financing module is configured to verify the financial information of the potential buyer before providing the financial information to the financial services process.

27. The system of claim 21, wherein the interface module is configured to transmit to the computing device usable by the potential buyer, a purchase offer comprising the purchase price known to be acceptable to the dealer and known to be acceptable to the potential buyer.

28. The system of claim 21, wherein the financing module is configured to electronically execute a financing package between a financial institution and the potential buyer.

29. The system of claim 21, wherein acceptance of the transaction comprises electronically executing a purchase agreement between the potential buyer and the dealer.

30. The system of claim 21, wherein the financial service process is configured to deliver financing approval based on, at least in part, the financial information of the potential buyer.

31. The system of claim 21, wherein the financial information comprises at least one of credit score, wealth, income, and employment.

32. The system of claim 21, wherein vehicles selected based, at least in part, on preferences of the potential buyer comprises performing analytics, the analytics comprising weighting preference parameters and financing parameters.
